(19) United States
(12) Patent Application Publication
(10) Pub. No.: US 2009/0074403 A1
(43) Pub. Date: Mar. 19, 2009

(54) SELF-HEALING RING-BASED PASSIVE OPTICAL NETWORK

(75) Inventors: Sien Chi, Hsinchu City (TW); Chien-Hung Yeh, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 12/016,214

(22) Filed: Jan. 18, 2008

(30) Foreign Application Priority Data
Sep. 19, 2007 (TW) 96134857

(51) Int. Cl. H04J 14/00; H04B 10/00

(52) U.S. Cl. 398/3

(57) ABSTRACT

A self-healing ring-based passive optical network (PON) including an optical fiber ring, an optical line termination (OLT), and a plurality of optical network units (ONUs) is provided. The optical fiber ring has a first end and a second end. The OLT is coupled to the first and the second end. The OLT receives a first signal from the first end or the first and the second end and transmits a second signal to the first end or the first and the second end. Each of the ONUs has a third end and a fourth end both coupled to the optical fiber ring. Each of the ONUs receives the second signal from the third and the fourth end and transmits the first signal to the third and the fourth end. The ONUs connect to the OLT through the optical fiber ring so as to form a ring-based PON.

### CROSS-REFERENCE TO RELATED APPLICATION

This application claims the priority benefit of Taiwan application serial no. 96134857, filed on Sep. 19, 2007. The entirety of the above-mentioned patent application is hereby incorporated by reference herein and made a part of this specification.

### BACKGROUND OF THE INVENTION

1. Field of the Invention

The present invention generally relates to a ring-based passive optical network (PON), in particular, to a self-healing ring-based PON.

2. Description of Related Art

The quantity of data transmitted over networks increases along with the increase in network users. In the conventional communication technique wherein data is transmitted as electric signals, network congestion may be caused due to the bandwidth limitation of the electric signals. Thus, optical fiber communication is adopted by many network service providers for providing various network services to network users.

Optical fiber communication offers greater bandwidth than wireless or cable communication using electric signals therefore can transmit data of larger quantity and provide better network services. Presently, passive optical network (PON) is usually adopted by optical fiber communication systems. A PON is easy to maintain and consumes less power because it uses passive devices and requires less switching equipment. Nowadays, many countries are dedicated to the development of PONs such as fiber to the home (FFTH), fiber to the curb (FFTC), and fiber to the building (FFTB) by using optical fiber communication techniques in order to allow network users to transmit and receive data in high speed and large quantity. Accordingly, PON is playing as one of today's major communication techniques.

The topologies of PON can be categorized into tree topology (or referred as star topology), bus topology, and ring topology. In addition, the multiplexing patterns of PON include time division multiplexing (TDM), wave division multiplexing (WDM), and code division multiplexing (CDM) etc. A PON of different topology and multiplexing pattern (for example, a ring-based TDM PON, a tree-based CDM PON, or a bus-based TDM PON) can be established according to the actual requirement and environment.

FIG. 1A is a diagram of a conventional ring-based PON 1A_Net. The ring-based PON 1A_Net includes n optical network units (ONUs) 1A_ONU1, 1A_ONU2, . . . , and 1A_ONUn, an optical fiber ring 1A_FIBER_RING, and an optical line termination (OLT) 1A_OLT. As shown in FIG. 1A, two transceiving ends of the optical fiber ring 1A_FIBER_RING are connected to the OLT 1A_OLT and the ONUs 1A_ONU1˜1A_ONUn connect to the OLT 1A_OLT through the optical fiber ring 1A_FIBER_RING so as to form the ring-based PON 1A_Net and to communicate with each other.

The OLT 1A_OLT transmits a downstream signal (indicated by a real line arrow in FIG. 1A) and receives an upstream signal (indicated by a dotted line arrow in FIG. 1A). The ONUs 1A_ONU1˜1A_ONUn receive the downstream signal and transmit the upstream signal. To achieve a full duplex function, the upstream signal and the downstream signal are optical signals having different wavelengths, for example, the wavelength of the upstream signal is 1310 nm, and the wavelength of the downstream signal is 1490 nm.

If the optical fiber ring 1A FIBER_RING has no fault, the OLT 1A_OLT and the ONUs 1A_ONU1˜1A_ONUn in the ring-based PON 1A_NET can communicate with each other through different multiplexing patterns (for example, TDM) without any collision.

However, a fault may be produced in the optical fiber ring due to some human error (for example, fire) or force majeure (for example, earthquake and typhoon). In this case, those ONUs after the fault cannot connect to the OLT or communicate with each other. FIG. 1B is a diagram of the ring-based PON 1A_NET with a fault 1A_FAULT produced in the optical fiber ring 1A_FIBER_RING. As shown in FIG. 1B, when the fault 1A_FAULT is produced on the ONUs 1A_ONU3 and 1A_ONU4, the ONUs 1A_ONU4˜1A_ONUn after the fault 1A_FAULT cannot connect to the OLT 1A_OLT or communicate with each other any more, and accordingly the upstream signals of the ONUs 1A_ONU4˜1A_ONUn cannot be transmitted to the OLT 1A_OLT and the downstream signals of the OLT 1A_OLT cannot be transmitted to the ONUs 1A_ONU4˜1A_ONUn.

FIG. 1C is a diagram of the structure and signals of the ONU 1A_ONU3 in FIG. 1B. The ONU 1A_ONU3 includes a bidirectional optical coupler (CPR) 1C0, a transceiver 1C1, and a medium access control (MAC) interface 1C2. The bidirectional optical coupler 1C0 is connected to the transceiver 1C1. The MAC interface 1C2 controls the transceiver 1C1 to transmit an upstream signal and receive a down stream signal. The bidirectional optical coupler 1C0 is a 1×2 bidirectional optical coupler having ends CPR_0, CPR_1, and CPR_2, and the bidirectional optical coupler 1C0 transmits the downstream signal received from the end CPR_0 thereof to the ends CPR_1 and CPR_2 thereof and transmits the upstream signal received from the ends CPR_1 and CPR_2 thereof to the end CPR_0 thereof. In the present example, no upstream signal is received at the end CPR_1 since the fault 1A_FAULT is produced on the ONUs 1A_ONU3 and 1A_ONU4.

The transceiver 1C1 includes a transmitter 1C10, a receiver 1C11, and a wave division multiplexer 1C12. The wave division multiplexer 1C12 is connected to the transmitter 1C10 and the receiver 1C11. The transmitter 1C10 transmits an upstream signal having a wavelength of 1310 nm, the receiver 1C11 receives a downstream signal having a wavelength of 1490 nm, and the transmitter 1C10 and the receiver 1C11 are controlled by the MAC interface 1C2. The wave division multiplexer 1C12 transmits the received downstream signal to the receiver 1C11 and transmits the upstream signal received from the transmitter 1C10 to the bidirectional optical coupler 1C0.

The other ONUs 1A_ONU1˜1A_ONU2 and ONUs 1A_ONU4˜1A_ONUn have the same structure as the ONU 1A_ONU3.

As described above, when a fault is produced in the optical fiber ring of a ring-based PON, those ONUs after the fault wont' be able to connect ot the OLT or communicate with each other. If those regions after the fault communicate with other regions through only this ring-based PON and those regions after the fault are in emergency when the fault is produced by some human error or force majeure, rescue work may be delayed due to the communication problem.

A self-healing ring-based PON is to be developed in order to allow the ONUs after a fault to connect to an OLT and communicate with each other.

### SUMMARY OF THE INVENTION

Accordingly, the present invention relates to a self-healing ring-based passive optical network (PON), wherein when a fault is produced in an optical fiber ring of the ring-based PON, the self-healing ring-based PON can recover itself from the situation so that optical network units (ONUs) after the fault can still connect to an optical line termination (OLT) and communicate with each other.

The present invention provides an OLT which is adaptable to a self-healing ring-based PON.

The present invention provides an ONU which is adaptable to a self-healing ring-based PON.

The present invention provides a self-healing ring-based PON including an optical fiber ring, an OLT, and a plurality of ONUs. The optical fiber ring has a first end and a second end. The OLT is coupled to the first end and the second end. The OLT receives a first signal from the first end or the first and the second end and transmits a second signal to the first end or the first and the second end. Each of the ONUs has a third end and a fourth end both coupled to the optical fiber ring. Each of the ONUs receives the second signal from the third end and the fourth end and transmits the first signal to the third end and the fourth end. The ONUs connect to the OLT through the optical fiber ring so as to form a ring-based PON.

The present invention provides an OLT adaptable to a self-healing ring-based PON. The OLT includes a first transceiver and an optical coupler. The optical coupler is coupled to the first transceiver. The first transceiver transmits a second signal and receives a first signal. The optical coupler has a first transceiving end and a second transceiving end, and the optical coupler transmits the first signal from the first transceiving end or the first and the second transceiving end to the first transceiver and transmits the second signal from the first transceiver to the first transceiving end or the first and the second transceiving end.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a diagram of a conventional ring-based passive optical network (PON) 1A_Net.

FIG. 1B is a diagram of the ring-based PON 1A_NET with a fault.

FIG. 1C is a diagram of the structure and signals of an optical network unit (ONU) 1A_ONU3 in FIG. 1B.

FIG. 2A illustrates the operation of a self-healing ring-based PON 2A_NET with no fault according to an embodiment of the present invention.

FIG. 2B illustrates the operation of the self-healing ring-based PON 2A_NET with a fault 2A_FAULT according to an embodiment of the present invention.

FIG. 3A is a structural diagram of an optical line termination (OLT) 2A_OLT which operates with no fault.

FIG. 3B is a diagram of the OLT 2A_OLT which operates with a fault 2A_FAULT.

FIG. 4A is a structural diagram of an ONU 2A_ONU3.

FIG. 4B is a diagram illustrating that a Y-shape optical splitter 40 in the ONU 2A_ONU3 receives a downstream signal from end “a”.

FIG. 4C is a diagram illustrating that a Y-shape optical splitter 40 in the ONU 2A_ONU3 receives a downstream signal from end “b”.

FIG. 5A is a diagram of a self-healing ring-based PON 5A_NET with a fault 5A_FAULT according to an embodiment of the present invention.

FIG. 5B is a performance analysis diagram of the bit error rate (BER) of a downstream signal in the self-healing ring-based PON 5A_NET.

FIG. 5C is a performance analysis diagram of the BER of an upstream signal in the self-healing ring-based PON 5A_NET.

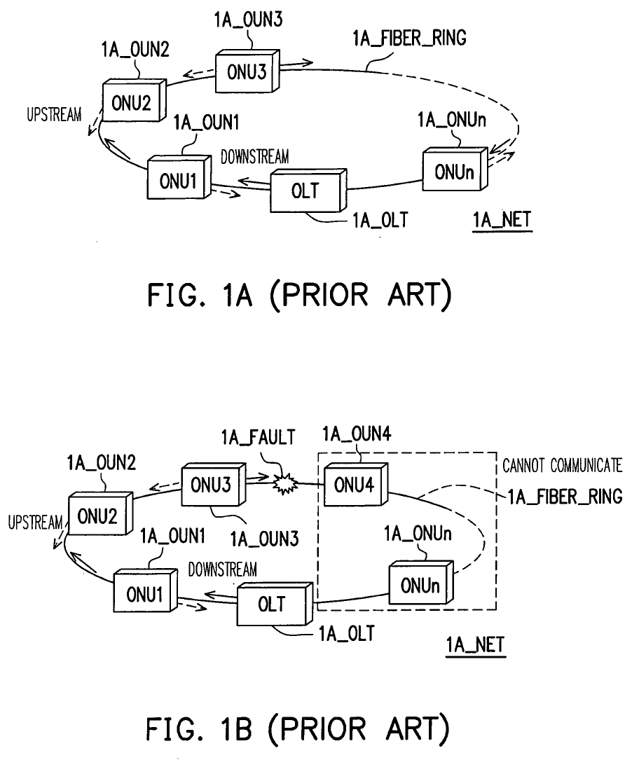

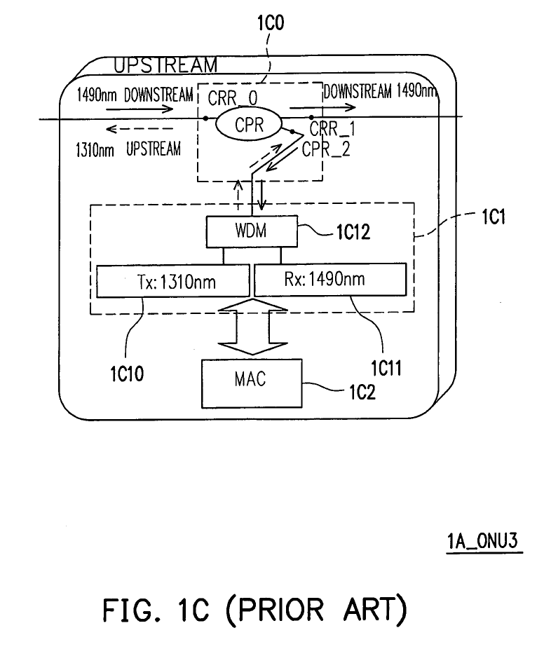

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In the present invention, an intelligent optical line termination (OLT) and a plurality of optical network units (ONUs) which can both receive and transmit signals are adopted for forming a ring-based passive optical network (PON) which has self-healing function. Thereby, when a fault is produced in an optical fiber ring of the ring-based PON, the OLT automatically detects the fault and the address thereof, and then the OLT switches from unidirectional receiving/transmitting to bidirectional receiving/transmitting so that the ONUs after the fault can still connect to the OLT and communicate with each other.

According to an exemplary embodiment of the present invention, the OLT further includes a medium access control (MAC) interface for controlling the first transceiver and the optical coupler. The MAC interface further determines whether an optical fiber ring connected to the OLT has a fault and calculates the address of the fault according to the received first signal. The optical coupler includes a first bidirectional optical coupler and an optical switch. The optical switch is coupled to the first bidirectional optical coupler and is controlled by the MAC interface.

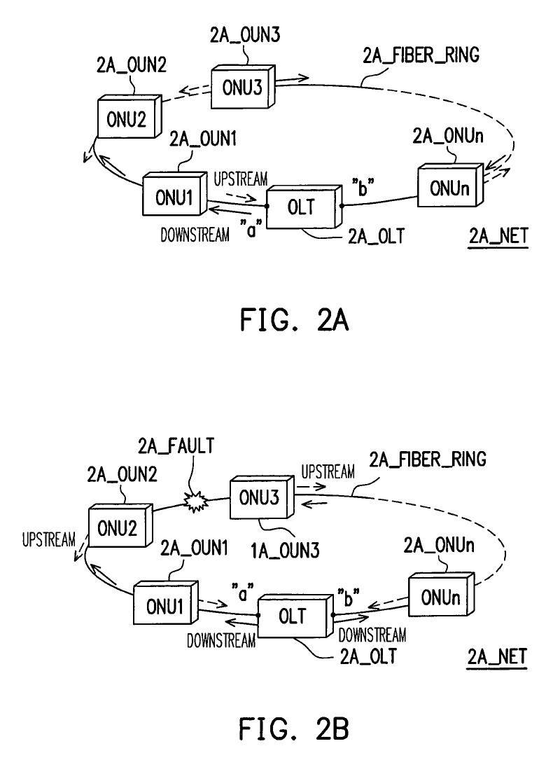

FIG. 2A illustrates the operation of a self-healing ring-based PON 2A_NET with no fault according to an embodiment of the present invention. As shown in FIG. 2A, the self-healing ring-based PON 2A_NET includes n optical network units, 2A_ONU1, 2A_ONU2, . . . , and 2A_ONUn, an optical fiber ring 2A_FIBER_RING, and an OLT 2A_OLT. Two ends “a” and “b” of the optical fiber ring 2A_FIBER_RING are connected to the OLT 2A_OLT. The ONUs 2A_ONU1˜2A_ONUn connect to the OLT 2A_OLT through the optical fiber ring 2A_FIBER_RING so as to form the ring-based PON 2A_NET and communicate with each other.

When the optical fiber ring 2A_FIBER_RING has no fault, the OLT 2A_OLT receives an upstream signal (indicated by a dotted-line arrow in FIG. 2A) from end “a” and transmits a downstream signal (indicated by a real-line arrow in FIG. 2A) to end “a”. Each of the ONUs 2A_ONU1˜2A_ONUn has two transceiving ends both coupled to the optical fiber ring 2A_FIBER_RING. Each of the ONUs 2A_ONU1˜2A_ONUn is a bidirectional ONU which receives a downstream signal from the two transceiving ends thereof and transmits an upstream signal to the two transceiving ends thereof. In FIG. 2A, each of the ONUs 2A_ONU1˜2A_ONUn receives a downstream signal from only one of the two transceiving ends thereof and transmits an upstream signal to only one of the two transceiving ends thereof because in the present embodiment, the other transceiving end of the ONU cannot receive the downstream signal and the upstream signal transmitted by the other transceiving end of the ONU cannot be received by the OLT 2A_OLT.

When there is no fault in the optical fiber ring 2A_FIBER_RING (as shown in FIG. 2A), the self-healing ring-based PON 2A_NET provided by the present invention is very similar to a conventional ring-based PON.

However, faults may be produced in the optical fiber ring due to human errors (for example, fire) or force majeure (for example, earthquake and typhoon). When a fault is produced in an optical fiber ring, the ONUs in the self-healing ring-based PON provided by the present invention after the fault can still connect to the OLT and communicate with each other.

FIG. 2B illustrates the operation of the self-healing ring-based PON 2A_NET with a fault 2A_FAULT according to an embodiment of the present invention. When the fault 2A_FAULT is produced in the optical fiber ring 2A_FIBER_RING, the OLT 2A_OLT receives an upstream signal from end “a” and end “b” and transmits a downstream signal to end “a” and end “b”. In other words, when the OLT 2A_OLT detects the fault 2A_FAULT, the OLT 2A_OLT switches from unidirectional receiving/transmitting (only transmitting a downstream signal and receiving an upstream signal at end “a”) to bidirectional receiving/transmitting (transmitting downstream signals and receiving upstream signals at both end “a” and end “b”). Each of the ONUs 2A_ONU1˜2A_ONUn has two transceiving ends both coupled to the optical fiber ring 2A_FIBER_RING. Each of the ONUs 2A_ONU1˜2A_ONUn is a bidirectional ONU which receives a downstream signal from the two transceiving ends thereof and transmits an upstream signal to the two transceiving ends thereof. Accordingly, the ONUs 2A_ONU1˜2A_ONUn after the fault 2A_FAULT can still transmit upstream signals to end “b” to be received by the OLT 2A_OLT, and the OLT 2A_OLT can still transmit downstream signals from end “b” to the ONUs 2A_ONU1˜2A_ONUn. Thereby, in the self-healing ring-based PON 2A_NET provided by the present invention, the ONUs 2A_ONU1˜2A_ONUn after the fault 2A_FAULT can still connect to the OLT 2A_OLT and communicate with each other.

According to the present invention, an intelligent OLT 2A_OLT and bidirectional ONUs 2A_ONU1˜2A_ONUn are adopted to form a self-healing ring-based PON 2A_NET. It will be understood that various changes in form and details of foregoing elements and structure may be made therein without departing from the spirit and scope of the present invention.

In addition, to achieve a full duplex function, the upstream signal and the downstream signal are optical signals having different wavelengths. For example, the wavelength of the upstream signal is 1310 nm, and the wavelength of the downstream signal is 1490 nm. Besides, the OLT 2A_OLT and the ONUs 2A_ONU1˜2A_ONUn in the self-healing ring-based PON 2A_NET can communicate with each other through different multiplexing patterns, such as time division multiplexing (TDM), without any collision. However, foregoing embodiment is not intended for restricting the present invention, and various changes in form and details may be made therein without departing from the spirit and scope of the present invention as defined by the following claims.

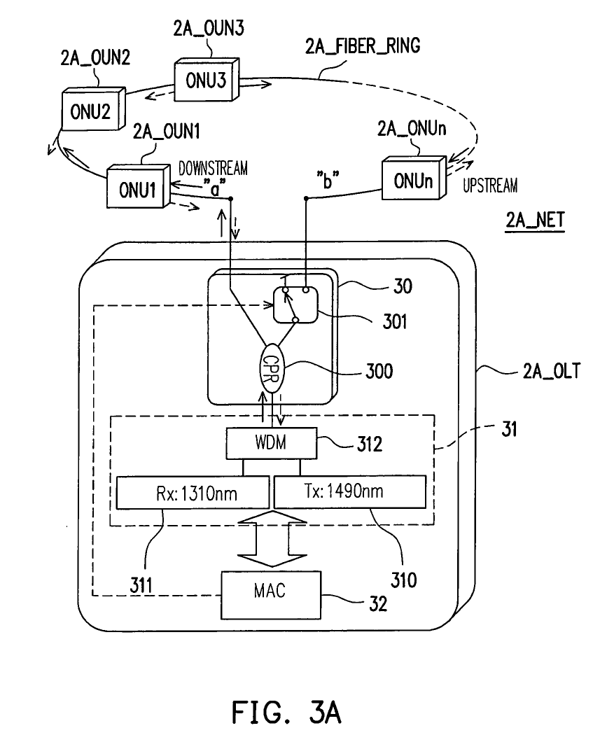

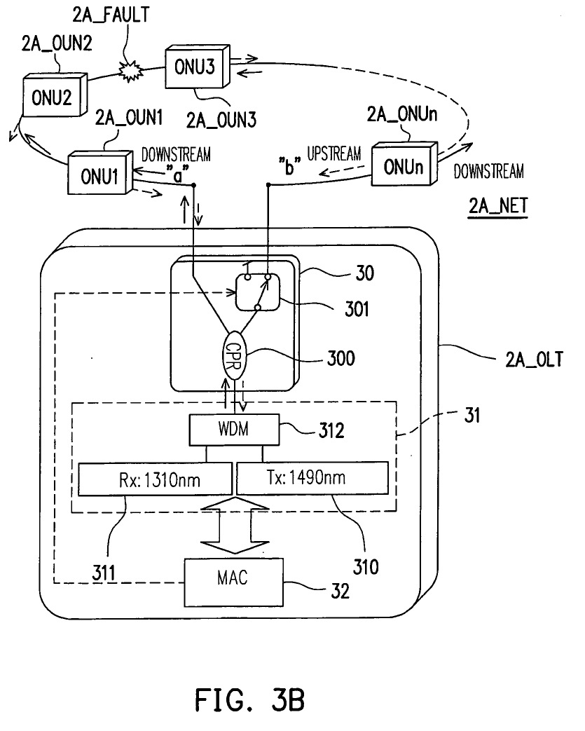

FIG. 3A is a structural diagram of an OLT 2A_OLT which operates with no fault, and FIG. 3B is a diagram of the OLT 2A_OLT which operates with a fault 2A_FAULT. As shown in FIG. 3A, the OLT 2A_OLT includes a first transceiver 31 and an optical coupler 30. The optical coupler 30 is coupled to the first transceiver 31. The first transceiver 31 transmits a downstream signal and receives an upstream signal. The optical coupler 30 receives the upstream signal from end “a” or from both end “a” and end “b” and transmits the upstream signal to the first transceiver 31, and the first transceiver 31 transmits the downstream signal from the first transceiver 31 to end “a” or to both end “a” and end “b”. As shown in FIG. 3A, the optical fiber ring 2A_FIBER_RING has no fault, therefore the optical coupler 30 receives the upstream signal from only end “a” and transmits the upstream signal to the first transceiver 31, and the first transceiver 31 transmits the down stream signal from the first transceiver 31 to only end “a”. As shown in FIG. 3B, the optical fiber ring 2A FIBER_RING has a fault 2A_FAULT, thus, the optical coupler 30 receives the upstream signal from both end “a” and end “b” and transmits the upstream signal to the first transceiver 31, and the first transceiver 31 transmits the downstream signal from the first transceiver 31 to both end “a” and end “b”. The optical coupler 30 allows the OLT 2A_OLT to switch from unidirectional receiving/transmitting to bidirectional receiving/transmitting when the optical fiber ring 2A_FIBER_RING has the fault 2A_FAULT, so that a self-healing function can be achieved by the ring-based PON 2A_NET.

Referring to FIG. 3A and FIG. 3B again, the OLT 2A_OLT further includes a medium access control (MAC) interface 32 for controlling the first transceiver 31 and the optical coupler 30. The MAC interface 32 controls the first transceiver 31 so as to achieve multiplexing (for example, TDM) so that collision won't be produced in the ring-based PON 2A_NET. Besides, the MAC interface 32 further determines whether the optical fiber ring 2A_FIBER_RING has the fault 2A_FAULT and calculates the address of the fault 2A_FAULT according to the received upstream signal. For example, the MAC interface 32 calculates the address of the fault 2A_FAULT according to the power or the delay time of the received upstream signal.

Referring to FIG. 3A and FIG. 3B again, the optical coupler 30 includes a bidirectional optical coupler 300 and an optical switch 301. The optical switch 301 is coupled to the bidirectional optical coupler 300 and is controlled by the MAC interface 32. As shown in FIG. 3A, when the optical fiber ring 2A_FIBER_RING has no fault, the optical switch prevents the bidirectional optical coupler 300 from transmitting the downstream signal to end “b” and receiving the upstream signal from end “b”, and here the bidirectional optical coupler 300 receives the upstream signal from only end “a” and transmits the upstream signal to end “a”. As shown in FIG. 3B, when the optical fiber ring 2A_FIBER_RING has a fault 2A_FAULT, the optical switch 301 allows the bidirectional optical coupler 300 to transmit the downstream signal to end “b” and receive the upstream signal form end “b”, and here the bidirectional optical coupler 300 receives the upstream signal from end “a” and end “b” and transmits the upstream signal to the end “a” and end “b”. In the present embodiment, the bidirectional optical coupler 300 may be a 1×2 bidirectional optical coupler, and the optical switch 301 may be a 1×2 bidirectional optical switch; however, the present invention is not limited thereto.

Referring to FIG. 3A and FIG. 3B again, the first transceiver 31 includes a first transmitter 310, a first receiver 311, and a wave division multiplexer 312. The wave division multiplexer 312 is coupled to the first transmitter 310 and the first receiver 311. The first transmitter 310 is controlled by the MAC interface 32 for transmitting a downstream signal. The first receiver 311 is controlled by the MAC interface 32 for receiving an upstream signal. The wave division multiplexer 312 transmits the upstream signal from the optical coupler 30 to the first transmitter 310 and transmits the downstream signal from the first transmitter 310 to the optical coupler 30. The first transmitter 310 may be a direct modulator for transmitting optical signals of 1490 nm, and the first receiver 311 may be a photo detector (PD) for receiving optical signals of 1310 nm. However, the first transmitter 310 and the first receiver 311 may also be embodied differently in the present invention. For example, the first transmitter 310 may also be an external modulator for transmitting optical signals of 1490 nm, and the first receiver 311 may also be an avalanche photo detector (APD) for receiving optical signals of 1310 nm.

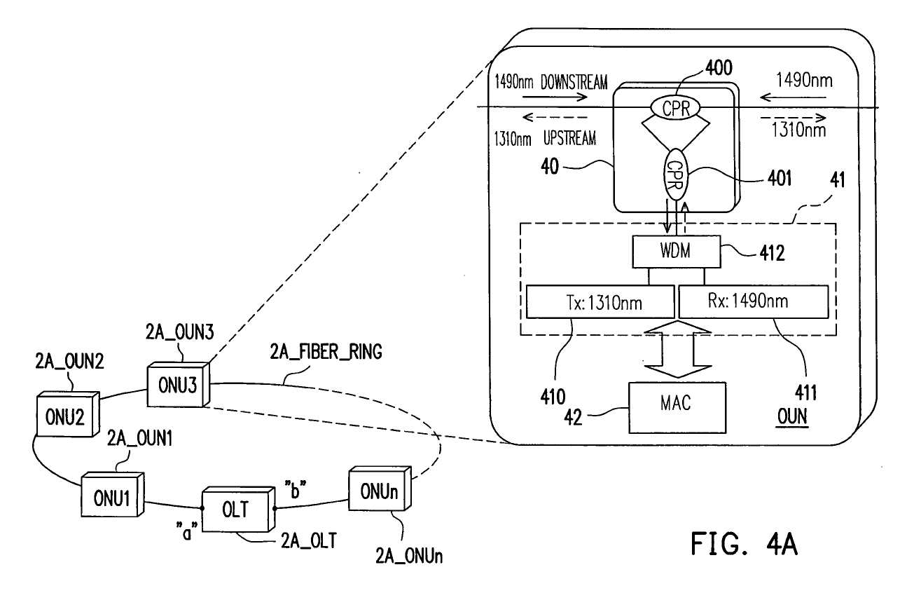

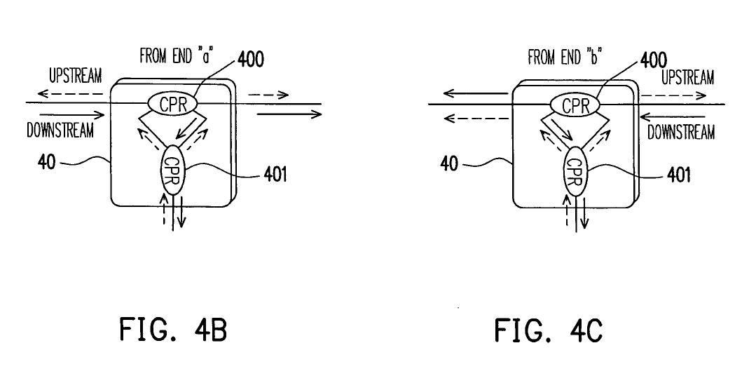

FIG. 4A is a structural diagram of an ONU 2A_ONU3, FIG. 4B is a diagram illustrating that a Y-shape optical splitter 40 in the ONU 2A_ONU3 receives a downstream signal from end “a”, and FIG. 4C is a diagram illustrating that a Y-shape optical splitter 40 in the ONU 2A_ONU3 receives a downstream signal from end “b”. FIGS. 4A˜4C illustrate only the structure of the ONU 2A_ONU3 and the operation thereof when the ONU 2A_ONU3 receives the downstream signal; however, the structures and operations of the other ONUs 2A_ONU1, 2A_ONU2, 2A_ONU4, and 2A_ONUn are the same as those of the ONU 2A_ONU3.

As shown in FIG. 4A, the ONU 2A_ONU3 includes a second transceiver 41, two transceiving ends (one goes towards end “a”, and the other one goes towards end “b”), and a Y-shape optical splitter 40. The Y-shape optical splitter 40 is coupled to the second transceiver 41. The second transceiver 41 transmits an upstream signal and receives a downstream signal. The Y-shape optical splitter 40 transmits the downstream signal from the two transceiving ends thereof (as shown in FIGS. 4A˜4C) to the second transceiver 41 and transmits the upstream signal from the second transceiver 41 to the two ends thereof (as shown in FIGS. 4A˜4C). As shown in FIG. 4B, the Y-shape optical splitter 40 receives the downstream signal from one transceiving end thereof (towards end “a”) and transmits the downstream signal to the other transceiving end thereof (towards end “b”), and the Y-shape optical splitter 40 also transmits the upstream signal to the two transceiving ends thereof. Similarly, as shown in FIG. 4C, the Y-shape optical splitter 40 receives the downstream signal from one transceiving end thereof (towards end “b”) and transmits the downstream signal to the other transceiving end thereof (towards end “a”), and the Y-shape optical splitter 40 transmits the upstream signal to the two transceiving ends thereof. The Y-shape optical splitter 40 includes two bidirectional optical couplers 400 and 401, wherein the bidirectional optical coupler 401 is coupled to the second transceiver 41 and the bidirectional optical coupler 400, and the bidirectional optical coupler 400 is coupled to the two transceiving ends of the Y-shape optical splitter 40. The bidirectional optical couplers 400 and 401 may be 1×2 bidirectional optical couplers; however, the present invention is not limited thereto.

Referring to FIGS. 4A˜4C again, the ONU 2A_ONU3 further includes a MAC interface 42 for controlling the second transceiver 41. The second transceiver 41 includes a second transmitter 410, a second receiver 411, and a wave division multiplexer 412. The wave division multiplexer 412 is coupled to the second transmitter 410 and the second receiver 411. The second transmitter 411 is controlled by the MAC interface 42 for transmitting an upstream signal. The second receiver 411 is controlled by the MAC interface 42 for receiving the downstream signal. The wave division multiplexer 412 transmits the downstream signal from the Y-shape optical splitter 40 to the second receiver 411 and transmits the upstream signal from the first transmitter 410 to the Y-shape optical splitter 40.

The second transmitter 410 may be a direct modulator for transmitting an optical signal of 1310 nm, and the second receiver 411 may be a PD for receiving an optical signal of 1490 nm. However, the implementations of the second transmitter 410 and the second receiver 411 are not limited in the present invention. For example, the second transmitter 410 may also be an external modulator for transmitting an optical signal of 1310 nm, and the second receiver 411 may also be an APD for receiving an optical signal of 1490 nm.

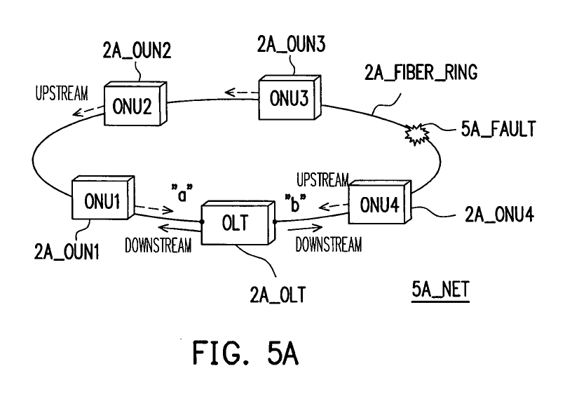

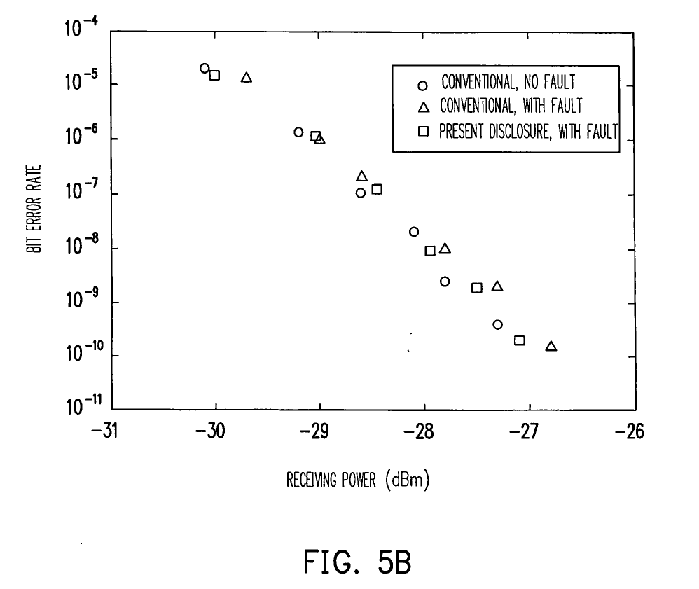

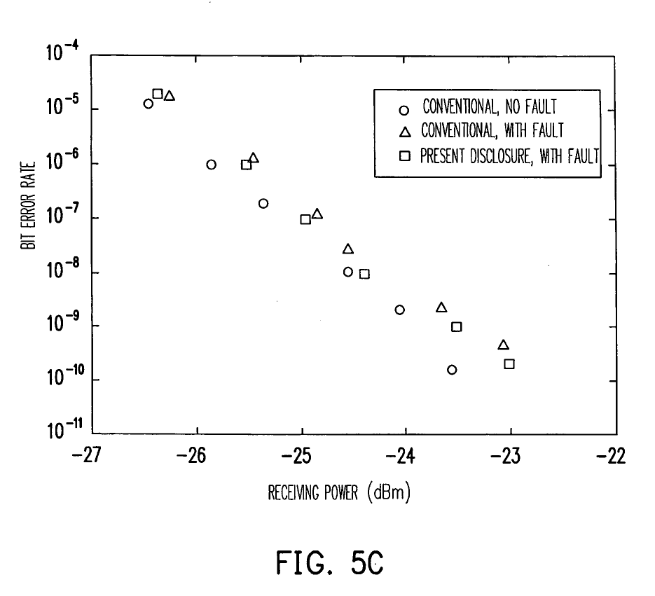

FIG. 5A is a diagram of a self-healing ring-based PON 5A_NET with a fault 5A_FAULT according to an embodiment of the present invention, FIG. 5B is a performance analysis diagram of the bit error rate (BER) of a downstream signal in the self-healing ring-based PON 5A_NET, and FIG. 5C is a performance analysis diagram of the BER of an upstream signal in the self-healing ring-based PON 5A_NET. As shown in FIG. 5A, the self-healing ring-based PON5A_NET has four ONUs 2A_ONU1˜2A_ONU4, the fault 5A_FAULT is located between the ONU 2A_ONU3 and the ONU 2A_ONU4, the transmission rate of the network is 1.25 Gbps, the distance from end “a” to the ONU 2A_ONU4 is 20 km, and the distance from end “b” to the ONU 2A_ONU4 is 5 km. As shown in FIG. 5B and FIG. 5C, the power penalty of the self-healing ring-based PON5A_NET having the fault 5A_FAULT is smaller than 0.4 dB.

In summary, according to the present invention, if a fault is produced in an optical fiber ring of a self-healing ring-based PON, those ONUs after the fault can still connect to an OLT and communicate with each other, and the power penalty produced by the self-healing ring-based PON is smaller than 0.4 dB with the same BER.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A self-healing ring-based passive optical network (PON), comprising
an optical fiber ring, having a first end and a second end;
an optical line termination (OLT), coupled to the first end and the second end, the OLT receiving a first signal from the first end or the first and the second end and transmitting a second signal to the first end or the first and the second end; and
a plurality of optical network units (ONUs), each of the ONUs having a third end and a fourth end both coupled to the optical fiber ring, each of the ONUs receiving the second signal from the third end and the fourth end and transmitting the first signal to the third end and the fourth end,
wherein the ONUs connect to the OLT through the optical fiber ring so as to form a ring-based PON.

2. The self-healing ring-based PON according to claim 1, wherein when the optical fiber ring has no fault, the OLT receives the first signal from the first end and transmits the second signal to the first end; and when the optical fiber ring has a fault, the OLT receives the first signal from the first end and the second end and transmits the second signal to the first end and the second end.

3. The self-healing ring-based PON according to claim 1, wherein the OLT comprises:
a first transceiver, transmitting the second signal and receiving the first signal; and
an optical coupler, coupled to the first transceiver, the optical coupler receiving the first signal from the first end or the first end and the second end and transmitting the first signal to the first transceiver, and the optical coupler transmitting the second signal from the first transceiver to the first end or the first end and the second end.

4. The self-healing ring-based PON according to claim 3, wherein the OLT further comprises:
a medium access control (MAC) interface, controlling the first transceiver and the optical coupler.

5. The self-healing ring-based PON according to claim 4, wherein the MAC interface further determines whether the optical fiber ring has the fault and calculates an address of the fault according to the first signal.

6. The self-healing ring-based PON according to claim 4, wherein the optical coupler comprises:
a first bidirectional optical coupler; and
an optical switch, coupled to the first bidirectional optical coupler, the optical switch being controlled by the MAC interface,
wherein when the optical fiber ring has no fault, the optical switch prevents the first bidirectional optical coupler from transmitting the second signal to the second end and receiving the first signal from the second end, and here the first bidirectional optical coupler receives the first signal from the first end and transmits the second signal to the first end; and when the optical fiber ring has the fault, the optical switch allows the first bidirectional optical coupler to transmit the second signal to the second end and receive the first signal from the second end, and here the first bidirectional optical coupler receives the first signal from the first end and the second end and transmits the second signal to the first end and the second end.

7. The self-healing ring-based PON according to claim 6, wherein the first bidirectional optical coupler is a 1×2 bidirectional optical coupler, and the optical switch is a 1×2 bidirectional optical switch.

8. The self-healing ring-based PON according to claim 4, wherein the first transceiver comprises:
a first transmitter, controlled by the MAC interface for transmitting the second signal;
a first receiver, controlled by the MAC interface for receiving the first signal; and
a wave division multiplexer, coupled to the first transmitter and the first receiver, the wave division multiplexer transmitting the first signal from the optical coupler to the first receiver and transmitting the second signal from the first transmitter to the optical coupler.

9. The self-healing ring-based PON according to claim 1, wherein each of the ONUs comprises:
a second transceiver, transmitting the first signal and receiving the second signal; and
a Y-shape optical splitter, coupled to the second transceiver, the Y-shape optical splitter transmitting the second signal from the third end and the fourth end to the second transceiver and transmitting the first signal from the second transceiver to the third end and the fourth end.

10. The self-healing ring-based PON according to claim 9, wherein the Y-shape optical splitter comprises:
a second bidirectional optical coupler, coupled to the third end and the fourth end; and
a third bidirectional optical coupler, coupled to the second transceiver and the second bidirectional optical coupler.

11. The self-healing ring-based PON according to claim 10, wherein the second bidirectional optical coupler and the third bidirectional optical coupler are 1×2 bidirectional optical couplers.

12. The self-healing ring-based PON according to claim 9, wherein each of the ONUs further comprises:
a MAC interface, controlling the second transceiver.

13. The self-healing ring-based PON according to claim 12, wherein the second transceiver comprises:
a second transmitter, controlled by the MAC interface for transmitting the first signal;
a second receiver, controlled by the MAC interface for receiving the second signal; and
a wave division multiplexer, coupled to the second transmitter and the second receiver, the wave division multiplexer transmitting the second signal from the Y-shape optical splitter to the second receiver and transmitting the first signal from the first transmitter to the Y-shape optical splitter.

14. The self-healing ring-based PON according to claim 1, wherein the ring-based PON is a ring-based time division multiplexing (TDM) PON.

15. The self-healing ring-based PON according to claim 1, wherein the first signal is an upstream optical signal, and the second signal is a downstream optical signal.

16. The self-healing ring-based PON according to claim 1, wherein the step of calculating the address of the fault according to the first signal is to determine the address of the fault according to the power of the first signal or according to the delay time of the first signal.

17. An OLT, adaptable to a self-healing ring-based PON, the OLT comprising:
a first transceiver, transmitting a second signal and receiving a first signal; and
an optical coupler, coupled to the first transceiver, having a first transceiving end and a second transceiving end, the optical coupler transmitting the first signal from the first transceiving end or the first transceiving end and the second transceiving end to the first transceiver and transmitting the second signal from the first transceiver to the first transceiving end or the first transceiving end and the second transceiving end.

18. The OLT according to claim 17, wherein the OLT further comprises:
a MAC interface, controlling the first transceiver and the optical coupler.

19. The OLT according to claim 18, wherein the MAC interface further determines whether an optical fiber ring connected to the OLT has a fault and calculates an address of the fault according to the first signal.

20. The OLT according to claim 19, wherein when the optical fiber ring has the fault, the OLT receives the first signal from the first transceiving end and the second transceiving end and transmits the second signal to the first transceiving end and the second transceiving end; and when the optical fiber ring has no fault, the OLT receives the first signal from the first transceiving end and transmits the second signal to the first transceiving end.

21. The OLT according to claim 19, wherein the optical coupler comprises:
a first bidirectional optical coupler; and
an optical switch, coupled to the first bidirectional optical coupler, the optical switch being controlled by the MAC interface,
wherein when the optical fiber ring has no fault, the optical switch prevents the first bidirectional optical coupler from transmitting the second signal to the second transceiving end and receiving the first signal from the second transceiving end, and here the first bidirectional optical coupler receives the first signal from the first transceiving end and transmits the second signal to the first transceiving end; and when the optical fiber ring has the fault, the optical switch allows the first bidirectional optical coupler to transmit the second signal to the second transceiving end and receive the first signal from the second transceiving end, and here the first bidirectional optical coupler receives the first signal from the first transceiving end and the second transceiving end and transmits the second signal to the first transceiving end and the second transceiving end.

22. The OLT according to claim 21, wherein the first bidirectional optical coupler is a 1×2 bidirectional optical coupler, and the optical switch is a 1×2 bidirectional optical switch.

23. The OLT according to claim 19, wherein the first transceiver comprises:
a first transmitter, controlled by the MAC interface for transmitting the second signal;
a first receiver, controlled by the MAC interface for receiving the first signal; and
a wave division multiplexer, coupled to the first transmitter and the first receiver, the wave division multiplexer transmitting the first signal from the optical coupler to the first receiver and transmitting the second signal from the first transmitter to the optical coupler.

24. The OLT according to claim 17 being further adaptable to a ring-based TDM PON.

25. The OLT according to claim 17, wherein the first signal is an upstream optical signal, and the second signal is a downstream optical signal.

26. The OLT according to claim 19, wherein the step of calculating the address of the fault according to the first signal is to determine the address of the fault according to the power of the first signal or according to the delay time of the first signal.

27. An ONU, adaptable to a self-healing ring-based PON, the ONU comprising:
a third transceiving end;
a fourth transceiving end;
a second transceiver, transmitting a first signal and receiving a second signal; and
a Y-shape optical splitter, coupled to the second transceiver, the Y-shape optical splitter transmitting the second signal from the third transceiving end and the fourth transceiving end to the second transceiver and transmitting the first signal from the second transceiver to the third transceiving end and the fourth transceiving end.

28. The ONU according to claim 27, wherein the Y-shape optical splitter comprises:
a second bidirectional optical coupler, coupled to the third transceiving end and the fourth transceiving end; and
a third bidirectional optical coupler, coupled to the second transceiver and the second bidirectional optical coupler.

29. The ONU according to claim 28, wherein the second bidirectional optical coupler and the third bidirectional optical coupler are 1×2 bidirectional optical couplers.

30. The ONU according to claim 27 further comprising:
a MAC interface, controlling the second transceiver.

31. The ONU according to claim 30, wherein the second transceiver comprises:
a second transmitter, controlled by the MAC interface for transmitting the first signal;
a second receiver, controlled by the MAC interface for receiving the second signal; and
a wave division multiplexer, coupled to the second transmitter and the second receiver, the wave division multiplexer transmitting the second signal from the Y-shape optical splitter to the second receiver and transmitting the first signal from the first transmitter to the Y-shape optical splitter.

32. The ONU according to claim 27 being further adaptable to a ring-based TDM PON.

33. The ONU according to claim 27, wherein the first signal is an upstream optical signal, and the second signal is a downstream optical signal.
